(19) United States
(12) Patent Application Publication
(10) Pub. No.: US 2009/0089237 A1
(43) Pub. Date: Apr. 2, 2009

(54) METHOD AND SYSTEM FOR REMOTELY UPDATING DETECTION KNOWLEDGE OF SYSTEMS

(75) Inventors: Prasanna Hebbar, Karnataka (IN); Ashok Ramesh Bajaj, Pewaukee, WI (US); Gregory John Derzay, Pewaukee, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/863,825

(22) Filed: Sep. 28, 2007

(51) Int. Cl. G06F 17/00; G06N 5/02

(52) U.S. Cl. 706/47; 706/50; 706/59

(57) ABSTRACT

A method for remotely updating detection knowledge of a system is presented. The method includes remotely communicating a rule package to the system to incrementally update the knowledge base of the system, wherein the rule package comprises at least one or more rules. Further, the method includes verifying validity of the rule package. The method also includes generating a set of valid rules, a set of invalid rules, or both. In addition, the method includes deploying the set of valid rules. Additionally, the method includes enabling the valid rules. Systems and computer-readable medium that afford functionality of the type defined by this method is also contemplated in conjunction with the present technique.

### BACKGROUND

The invention relates generally to diagnosis of systems, and more particularly to detection systems.

Diagnostic imaging systems have emerged into an essential aspect of patient care. Medical images that are obtained via the diagnostic imaging sessions have evolved as tools that allow a clinician non-invasive means to view anatomical cross-sections of internal organs, tissues, bones and other anatomical regions of a patient. More particularly, the medical images serve the clinician in diagnosis of disease states, determination of suitable treatment options and/or monitoring the effects of treatment, to name a few. As will be appreciated, medical images may be obtained from a broad spectrum of imaging modalities, such as, but not limited to computed tomography (CT) imaging, ultrasound imaging, magnetic resonance (MR) imaging, digital mammography, X-ray imaging, nuclear medicine imaging, positron emission tomography (PET) imaging, or combinations of the above.

Additionally, the diagnostic imaging systems may also be configured to generate one or more log files. As will be appreciated, a log file may be representative of a file that lists actions that have occurred. More particularly, the log file may include functions and activities performed by the imaging system, often in a time-associated format, for example. Furthermore, the log file may include data representative of events, errors, machine critical parameters, sensor outputs, or a combination thereof. Accordingly, these log files may be used by a technician to facilitate detection of faults associated with the diagnostic imaging system and subsequent diagnosis and/or servicing.

Further, presently available techniques typically entail positioning a detection system in close proximity to the diagnostic imaging system to facilitate speedy acquisition of log files and hence aid in the quick detection of any faults. However, the positioning of the detection system in close proximity to the diagnostic imaging systems calls for the detection systems to be distributed and positioned in different geographical regions that are often remote from a back-office system. Additionally, identification of new detectable faults entails new rules to be authored. It may be desirable to communicate these new rules to the various remote detection systems, thereby presenting a challenge of incrementing the knowledge base of the remote detection systems, when new rules are authored.

A wide array of techniques has been developed to aid in updating the knowledge base of the detection systems with the newly authored rules. Unfortunately, these techniques generally entail a manual method of updating the knowledge bases of the remote detection systems, thereby resulting in a laborious, time-consuming and often error-prone process. This may be especially problematic in systems that handle high volumes of log data and may inordinately lead to delays in fault detection, diagnosis and subsequent servicing of the diagnostic imaging system, and hence may adversely affect system availability.

Additionally, the performance of the rules may be continually monitored. Based on the performance of the rules, it may be desirable to enable and/or disable rules either remotely and/or automatically. Furthermore, in certain situations, it may also be desirable to enable and/or disable rules either remotely and/or automatically based on business impact changes. Unfortunately, presently available techniques fail to allow rules to be remotely and/or automatically enabled and/or disabled based on the performance of the rules, business impact changes, or both.

It may therefore be desirable to develop a robust technique and system for systematically updating the detection knowledge base of one or more remote systems that advantageously facilitates superior fault detection, diagnosis and service of the diagnostic imaging system. In particular, there is a need for a system that may be configured to aid in enhancing ease of deploying newly authored rules to a plurality of remote systems, thereby simplifying the maintenance workflow of the diagnostic imaging system.

### BRIEF DESCRIPTION

In accordance with aspects of the present technique, a method for remotely updating a detection knowledge base of a system is presented. The method includes remotely communicating a rule package to the system to incrementally update the knowledge base of the system, where the rule package comprises at least one or more rules. Further, the method includes verifying validity of the rule package. The method also includes generating a set of valid rules, a set of invalid rules, or both. In addition, the method includes deploying the set of valid rules. Additionally, the method includes enabling the valid rules. Computer-readable medium that afford functionality of the type defined by this method is also contemplated in conjunction with the present technique.

In accordance with further aspects of the present technique, a detection system is presented. The detection system includes a remote connectivity module configured to receive a rule package from a remote source, where the rule package comprises one or more rules. In addition, the detection system includes a package validator module configured to verify validity of the rule package, and to generate a set of valid rules, a set of invalid rules, or both. Furthermore, the detection system includes a rule deployer module configured to deploy the set of valid rules. Moreover, the detection system includes a rule enabler module configured to enable the deployed rules.

In accordance with further aspects of the present technique, a system is presented. The system includes a data source, where the data source comprises an acquisition subsystem configured to acquire data, and a processing subsystem in operative association with the acquisition subsystem and configured to process the acquired data and generate log data. Additionally, the system includes a data storage subsystem, where the data storage subsystem comprises a data acquisition system configured to receive the log data, a data repository configured to store the log data, and a rule management platform configured to author one or more rules based on the log data, package the one or more authored rules to generate a rule package, and communicate the rule package to a detection subsystem. Furthermore, the system includes a detection subsystem in operative association with the data storage subsystem, where the detection subsystem comprises a remote connectivity module configured to receive a rule package from the data storage subsystem, where the rule package comprises one or more rules, a package validator module configured to verify validity of the rule package, generate a set of valid rules, a set of invalid rules, or both, a rule deployer module configured to deploy the set of valid rules, and a rule enabler module configured to enable the deployed rules.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary diagnostic system, in accordance with aspects of the present technique;

FIG. 2 is a block diagram of an imaging system configured for use in the diagnostic system of FIG. 1, in accordance with aspects of the present technique;

FIG. 3 is a block diagram of a portion of the exemplary diagnostic system of FIG. 1, in accordance with aspects of the present technique;

FIGS. 4A-4C are flow charts illustrating an exemplary process for remotely updating a detection knowledge base of a system, in accordance with aspects of the present technique;

FIG. 5 is a diagrammatic illustration of predefined rules, in accordance with aspects of the present technique;

FIG. 6 is a diagrammatic illustration of an exemplary process for remotely updating a detection knowledge base of a system, in accordance with aspects of the present technique;

FIG. 7 is a flow chart illustrating another exemplary process for remotely updating a detection knowledge base of a system, in accordance with aspects of the present technique; and

FIG. 8 is a flow chart illustrating yet another exemplary process for remotely updating a detection knowledge base of a system, in accordance with aspects of the present technique.

### DETAILED DESCRIPTION

As will be described in detail hereinafter, a method for remotely updating a detection knowledge base of one or more systems and a system for remotely updating a detection knowledge base of the one or more systems configured to enhance fault detection in diagnostic systems, are presented. Employing the method and system described hereinafter, the system for remotely updating a detection knowledge base may be configured to allow remotely updating the knowledge base of one or more remote systems with newly authored rules and/or updated versions of existing rules, thereby simplifying the workflow of the systems and optimizing the performance of the systems.

Although, the exemplary embodiments illustrated hereinafter are described in the context of a medical imaging system, it will be appreciated that use of the diagnostic system in industrial applications are also contemplated in conjunction with the present technique.

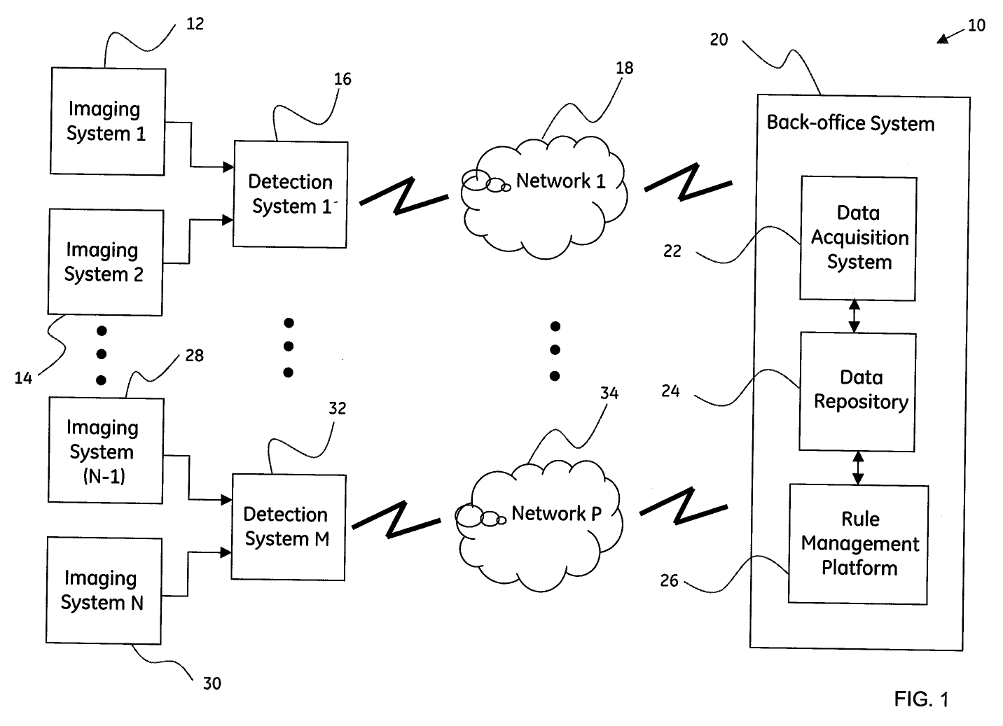

FIG. 1 is a block diagram of an exemplary system 10 for use in fault detection, in accordance with aspects of the present technique. More particularly, the system 10 may be configured to enhance fault detection in a plurality of imaging systems by remotely updating a detection knowledge base of one or more systems, such as detection systems. As will be appreciated by one skilled in the art, the figures are for illustrative purposes and are not drawn to scale. The system 10 may be configured to facilitate acquisition of image data from a patient (not shown in FIG. 1) via a plurality of imaging systems. In the illustrated embodiment of FIG. 1, the diagnostic system 10 is illustrated as including a first imaging system 12 and a second imaging system 14, where the first and second imaging systems 12, 14 are operatively coupled to a first detection system 16. It may be noted that the first imaging system 12 may be configured to obtain a first image data set representative of the patient under observation. In a similar fashion, the second imaging system 14 may be configured to facilitate acquisition of a second image data set associated with the same patient. Furthermore, the first detection system 16 may be disposed in relatively close proximity to the first and second imaging systems 12, 14. Alternatively, the first detection system 16 may be disposed remote from the imaging systems 12, 14, however, the first detection system 16 may be disposed within a local area network associated with the first and second imaging systems 12, 14.

It may be noted that although the exemplary embodiments illustrated hereinafter are described in the context of a medical imaging system, other imaging systems and applications such as industrial imaging systems and non-destructive evaluation and inspection systems, such as pipeline inspection systems, liquid reactor inspection systems, are also contemplated. Additionally, the exemplary embodiments illustrated and described hereinafter may find application in multi-modality imaging systems that employ ultrasound imaging in conjunction with other imaging modalities, position-tracking systems or other sensor systems. Furthermore, it should be noted that although the exemplary embodiments illustrated hereinafter are described in the context of a medical imaging system, such as, but not limited to, an ultrasound imaging system, an optical imaging system, a computed tomography (CT) imaging system, a magnetic resonance (MR) imaging system, an X-ray imaging system, or a positron emission tomography (PET) imaging system, other imaging systems, such as, but not limited to, a pipeline inspection system, a liquid reactor inspection system, or other imaging systems are also contemplated in accordance with aspects of the present technique. It may also be noted that the present technique may also find application in a wide variety of electronic systems. For example, use of the present technique in applications, such as, but not limited to, generators and wind turbines are also contemplated.

In accordance with one aspect of the present technique, the diagnostic system 10 may be representative of a multi-modality imaging system. In other words, a variety of imaging systems may be employed to obtain image data representative of the same patient. More particularly, in certain embodiments each of the first imaging system 12 and the second imaging system 14 may include a CT imaging system, a PET imaging system, an ultrasound imaging system, an X-ray imaging system, an MR imaging system, an optical imaging system or a combination thereof. For example, in one embodiment, the first imaging system 12 may include a CT imaging system, while the second imaging system 14 may include an ultrasound imaging system.

Further, in certain other embodiments, the diagnostic system 10 may include one imaging system, such as the first imaging system 12. In other words, the diagnostic system 10 may include a single modality imaging system. For example, the diagnostic system 10 may include only one imaging system 12, such as an ultrasound imaging system. In this embodiment, a plurality of images, such as a plurality of scans taken over a period of time, of the same patient may be obtained by the same imaging system 12.

In addition to acquiring image data, the first and second imaging systems 12, 14 may also be configured to respectively generate one or more log files. As will be appreciated, a log file may be representative of a file that lists actions that have occurred. More particularly, the log file may include functions and activities performed by the imaging systems 12, 14, often in a time-associated format, for example. Furthermore, the log file may include data representative of events, errors, machine critical parameters, sensor outputs, or a combination thereof. For example, log files generated by a medical imaging system, such as the first imaging system 12, may include information indicative of a machine state. The machine state information may be employed to detect failures associated with the first imaging system 12. Also, the log file may include machine-readable data.

Moreover, in a presently contemplated configuration, the first detection system 16 is shown as being operatively coupled to the first and second imaging systems 12, 14. Further, in the present example, the first detection system 16 is shown as being positioned in relatively close proximity to the imaging systems 12, 14. By way of example, the first detection system 16 may be disposed within a hospital network. Also, in one embodiment, the first detection system 16 may be at a location that is physically remote from the location of the imaging systems 12, 14. Furthermore, the imaging systems 12, 14 may be configured to communicate log files to the first detection system 16. By way of example, the imaging systems 12, 14 may be configured to push log files to the first detection system 16. Alternatively, the first detection system 16 may be configured to pull log files from the imaging systems 12, 14.

In addition, the first detection system 16 may be configured to aid in detection of faults. In other words, the first detection system 16 may be configured to parse through the data in the log files generated by the first and second imaging systems 12, 14 to extract information of interest based on predefined rules. The term information of interest may be used to refer to faults associated with the imaging systems 12, 14. Techniques, such as, but not limited to, standard file reading techniques, regular expression techniques, or transformation techniques may be employed by the first detection system 16 to parse through the log files to extract the information of interest.

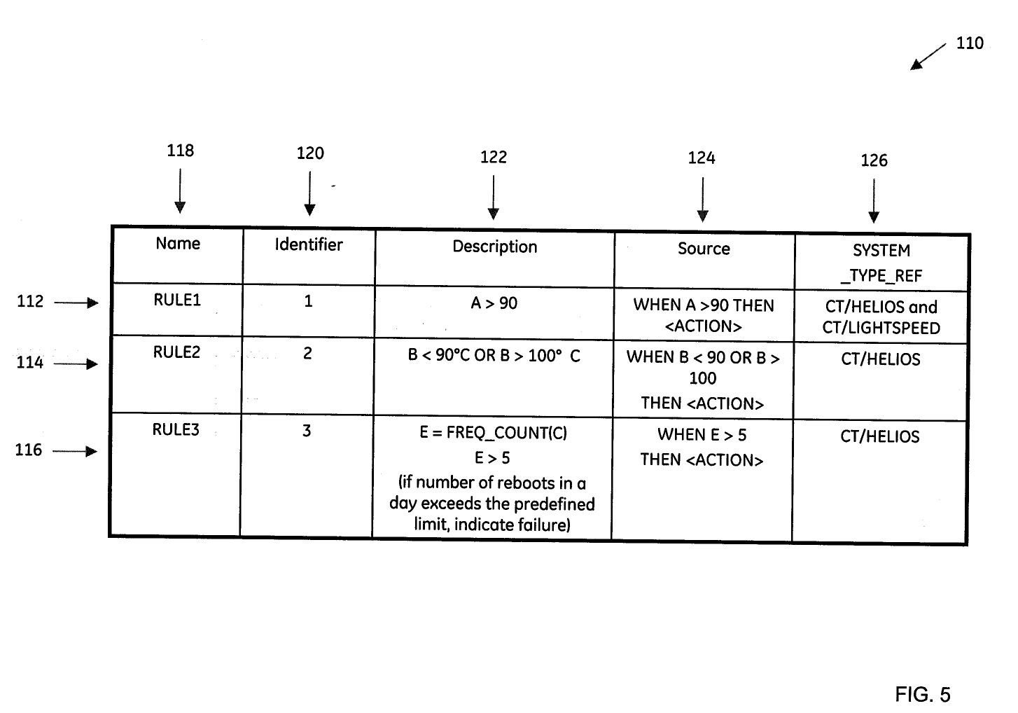

The predefined rules may be stored in a second storage (not shown in FIG. 1), in one embodiment. In a presently contemplated configuration, the second storage may include a rules database (not shown in FIG. 1) that is configured to store the predefined rules. An example of a set of predefined rules that is stored in the rules database will be described in greater detail with reference to FIG. 5. As used herein, the term “rule” may be used to refer to a predefined constraint that typically encompasses any and all actions that should be taken within the scope of a problem. These rules may be collectively referred to as a rule base, where the rule base may contain all of the knowledge associated with the rule-based system. The rules may be typically encoded into IF-THEN rules. As will be appreciated, a rule-based system may examine all the rule conditions (IF) and determine a subset, the conflict set, of the rules whose conditions are satisfied based on a working memory, where the working memory may include any data, assertions or initially known information. Subsequently, one of the rules chosen from the conflict set based on a conflict resolution strategy may be triggered. Following the triggering of a rule, any actions specified in the corresponding THEN clause may be carried out. These actions may modify the working memory, the rule-base, or execute any actions specified by the THEN clause. Moreover, one form of the rule is a business rule. A business rule may be configured to define and/or constrain an aspect of a business. Further, the business rule may be specified in formats different from the IF-THEN format.

Also, in accordance with aspects of the present technique, the predefined rules may be representative of information associated with the status of a system, such as the medical imaging systems 12, 14. For example, the predefined rules may be employed to aid in detecting system status or health of the medical imaging systems 12, 14. Also, a predefined set of parameters may be associated with a given imaging modality, where the imaging modality may include an imaging system, such as, but not limited to, an ultrasound system, an X-ray system, a MR imaging system, a CT imaging system, or a combination thereof. For example, the predefined rules may include a set of parameters associated with a CT imaging system, where the parameters may include a speed, a temperature, a pressure, number of disks, or percentage of disk usage. Additionally, the predefined rules may also include one or more indicators, where the indicators may be associated with one or more parameters. For example, an indicator associated with a temperature parameter may include an average of the temperature parameter recorded during a predetermined interval. Accordingly, for a given imaging modality, the predefined rules may include one or more rules based on various combinations of the associated parameters and/or indicators. Furthermore, a set of rules may be defined for each of the imaging modalities, where the rules may include parameter-based rules and/or indicator-based rules. Additionally, the predefined rules may also include other expressions to be extracted from the log file, where the expressions may be representative of error codes generated by the imaging systems 12, 14, for example.

As will be appreciated, the image data acquired via the first and second imaging systems 12, 14 may be stored in a database, for example. Additionally, the log files generated by the imaging systems 12, 14 and communicated to the first detection system 16 may be communicated to a first storage 20. In a presently contemplated configuration, the first storage 20 may include a data storage system. Also, in one embodiment, the data storage system 20 may be at a location that is physically remote from the location of the imaging systems 12, 14 and the first detection system 16. However, as will be appreciated, in certain embodiments, the data storage system 20 may be disposed in substantially close proximity to the imaging systems 12, 14 and/or the first detection system 16. In one embodiment, the data storage system 20 may include a back-office system. Also, it may be noted that the terms data storage system and back-office system may be used interchangeably.

Moreover, in one embodiment, the image data acquired via the first and second imaging systems 12, 14 may be communicated to the back-office system 20 via a first network 18. Additionally, the one or more log files generated by the first and second imaging systems 12, 14 may also be communicated to the back-office system 20 via the first network 18. It may be noted that other means of communication, such as, but not limited to, the Internet, the intranet, or wireless communication may also be employed to transmit the log files from the first detection system 16 to the back-office system 20. Furthermore, in one embodiment, the log files may be transmitted to the back-office system 20 in real-time. Alternatively, the log files may be temporarily stored in a temporary storage and communicated to the back-office system 20 at a later time.

With continuing reference to FIG. 1, in a presently contemplated configuration, the back-office system 20 may include a data acquisition subsystem 22, a data repository 24 and a rule management platform 26. The data acquisition subsystem 22 may be configured to receive image data from the imaging systems 12, 14 via the first network 18. Additionally, the data acquisition subsystem 22 may also be configured to receive the log files transmitted from the first detection system 16 via the first network 18. The log files received by the data acquisition system 22 may be stored in the data repository 24. In one embodiment, the data repository 24 may include an archival site, a database, or an optical data storage article. It may be noted that the optical data storage article may be an optical storage medium, such as a compact disc (CD), a digital versatile disc (DVD), multi-layer structures, such as DVD-5 or DVD-9, multi-sided structures, such as DVD-10 or DVD-18, a high definition digital versatile disc (HD-DVD), a Blu-ray disc, a near field optical storage disc, a holographic storage medium, or another like volumetric optical storage medium, such as, for example, two-photon or multi-photon absorption storage format.

In accordance with exemplary aspects of the present technique, the back-office system 20 may also include the rule management platform 26, where the rule management platform 26 may be configured to aid in analysis of the log data. More particularly, the rule management platform 26 may be configured to analyze the log data generated by the imaging systems 12, 14, for instance. As will be appreciated, as new detectable faults associated with the imaging systems 12, 14 are identified, it may be desirable to author new rules configured to facilitate the detection of the newly identified faults. Accordingly, the rule management platform 26 may be configured to facilitate identification of new faults. Furthermore, the rule management platform 26 may also be configured to aid in the generation of new rules, where the new rules may be configured to aid the first detection system 16 in the detection of the newly identified faults. The rule management platform 26 may also be configured to facilitate generation of updated and/or revised versions of existing rules.

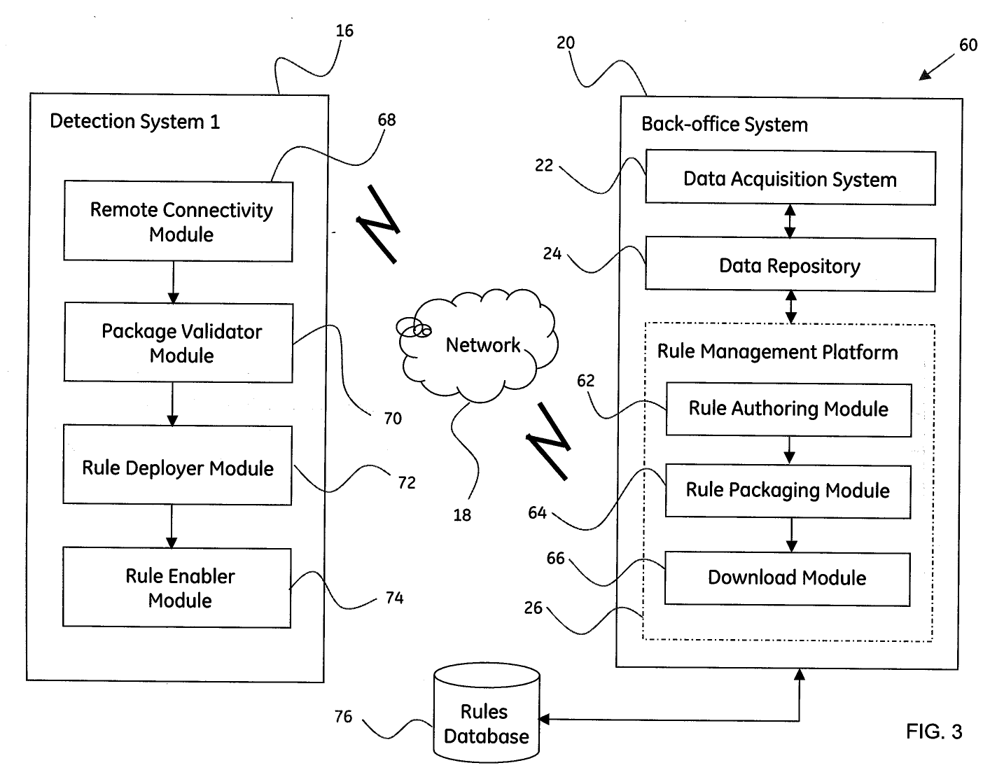

Once the new rules are authored, it may be desirable to update detection knowledge base of the first detection system 16 with the new rules. It may be noted that the new rules may include the newly authored rules and/or the updated versions of the existing rules. However, dissemination of these rules to incrementally enhance the detection knowledge base of detection systems located at a plurality of geographical locations is a challenging task. Additionally, based on performance of one or more rules and/or business impact changes, it may be desirable to enable and/or disable rules in the detection knowledge base of the detection systems. Accordingly, a system for remotely enhancing the detection knowledge base of one or more detection systems, in accordance with exemplary aspects of the present technique, is presented. In other words, the rule management platform 26 may be configured to facilitate remotely updating the detection knowledge base of the one or more remote detection systems. The working of the detection system 16 and the rule management platform 26 will be explained in greater detail with reference to FIGS. 3-8.

With continuing reference to FIG. 1, the diagnostic system 10 may also include a (N−1)^{th} imaging system 28 and a N^{th} imaging system 30, where the imaging systems 28, may be configured to generate respective log files. In the present example, the imaging systems 28, 30 are shown as being operatively coupled to a M^{th} detection system 32, where the M^{th} detection system 32 may be configured to facilitate detection of faults associated with the imaging systems 28, 30 by parsing through the data in log files generated by the imaging systems 28, 30. The M^{th} detection system 32 may be configured to communicate the log files to the back-office system 20 via a P^{th} network 34.

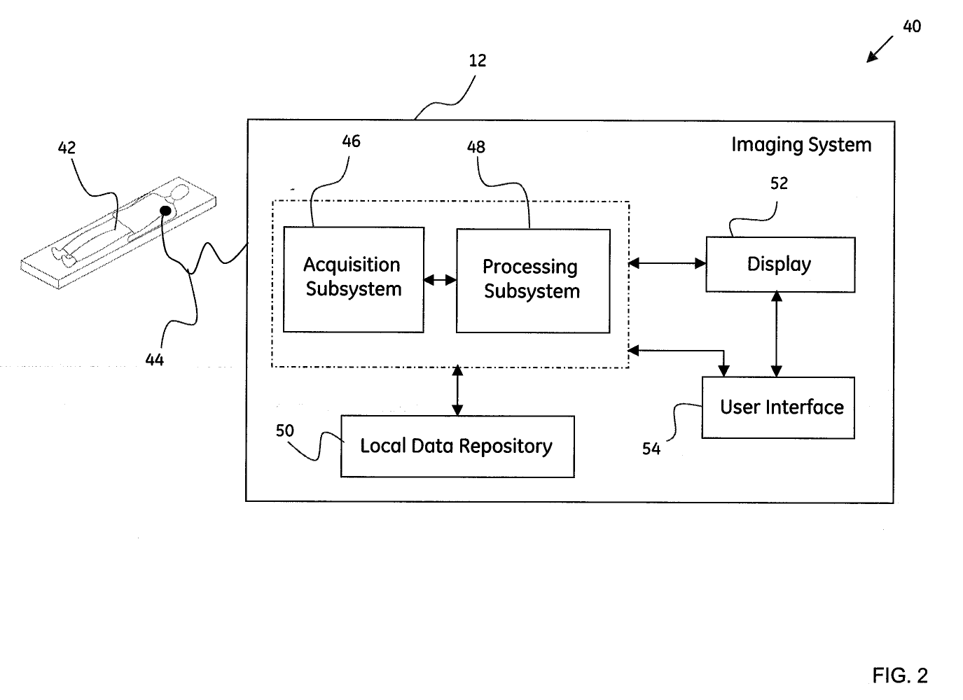

Referring now to FIG. 2, in accordance with aspects of the present technique, a block diagram of an exemplary system 40 configured for use in diagnostic system 10 (see FIG. 1), is illustrated. The system 40 may be configured to acquire image data from a patient 42 via an image acquisition device 44. In one embodiment, the image acquisition device 44 may include a probe, where the probe may include an invasive probe, or a non-invasive or external probe, such as an external ultrasound probe, that is configured to aid in the acquisition of image data. Also, in certain other embodiments, image data may be acquired via one or more sensors (not shown) that may be disposed on the patient 42. By way of example, the sensors may include physiological sensors (not shown) such as electrocardiogram (ECG) sensors and/or positional sensors such as electromagnetic field sensors or inertial sensors. These sensors may be operationally coupled to a data acquisition device, such as an imaging system, via leads (not shown), for example.

The system 40 may also include an imaging system, such as the first imaging system 12 (see FIG. 1) that is in operative association with the image acquisition device 44. In a presently contemplated configuration, the imaging system 12 may include a medical imaging system. It may be noted that although the present example illustrates the system 40 as including one imaging system 12, the system 40 may include more than one imaging system.

It may be noted that although the exemplary embodiments illustrated hereinafter are described in the context of a medical imaging system, other imaging systems and applications such as industrial imaging systems and non-destructive evaluation and inspection systems, such as pipeline inspection systems, liquid reactor inspection systems, are also contemplated. Furthermore, it should be noted that although the exemplary embodiments illustrated hereinafter are described in the context of a medical imaging system, such as, but not limited to, an ultrasound imaging system, an optical imaging system, a computed tomography (CT) imaging system, a magnetic resonance (MR) imaging system, an X-ray imaging system, or a positron emission tomography (PET) imaging system, other imaging systems, such as, but not limited to, a pipeline inspection system, a liquid reactor inspection system, or other imaging systems are also contemplated in accordance with aspects of the present technique.

In a presently contemplated configuration, the medical imaging system 40 may include an acquisition subsystem 46 and a processing subsystem 48. Further, the acquisition subsystem 46 of the medical imaging system 40 may be configured to acquire image data representative of one or more anatomical regions of interest in the patient 42 via the image acquisition device 44. The image data acquired from the patient 42 may then be processed by the processing subsystem 48.

Additionally, the image data acquired and/or processed by the medical imaging system 12 may be employed to aid the clinician in identifying disease states, assessing need for treatment, determining suitable treatment options, and/or monitoring the effect of treatment on the disease states. In certain embodiments, the processing subsystem 48 may be further coupled to a local storage system, such as a local data repository 50, where the local data repository 50 is configured to receive image data.

Also, as previously noted, the medical imaging system 12 may also be configured to generate one or more log files, where the data in the one or more log files may be representative of events, errors, machine critical parameters, sensor outputs, or a combination thereof. For example, log files generated by a medical imaging system, such as the medical imaging system 12, may include information indicative of a machine state. The machine state information may be employed to detect failures associated with the medical imaging system 12. In one embodiment, the processing subsystem 48 may be configured to generate the one or more log files.

Furthermore, as illustrated in FIG. 2, the medical imaging system 40 may also include a display 52 and a user interface 54. However, in certain embodiments, such as in a touch screen, the display 52 and the user interface 54 may overlap. Also, in some embodiments, the display 52 and the user interface 54 may include a common area. In accordance with aspects of the present technique, the display 52 of the medical imaging system 40 may be configured to display an image generated by the medical imaging system 40 based on the image data acquired via the image acquisition device 44. Additionally, in accordance with further aspects of the present technique, information of interest retrieved from the log files may be displayed on the display 52.

Further, the user interface 54 of the medical imaging system 40 may include a human interface device (not shown) configured to facilitate the clinician in organizing and/or managing image data and/or log data displayed on the display 52. The human interface device may include a mouse-type device, a trackball, a joystick, a stylus, or a touch screen. However, as will be appreciated, other human interface devices, such as, but not limited to, a touch screen, may also be employed.

Turning now to FIG. 3, a block diagram 60 of a portion of the diagnostic system 10 (see FIG. 1) is illustrated. More particularly, one embodiment of a detection system, such as the first detection system 16 (see FIG. 1) and the back-office system 20 of FIG. 1 is depicted. It may be noted the log files generated by imaging system 12, 14, 28, 30 (see FIG. 1) may be communicated by the corresponding detection systems to the back-office system 20 via corresponding networks. Also, the log files may be obtained from different imaging modalities. Alternatively, if a single imaging modality is employed to acquire image data, then the log files may be representative of log files generated by the single imaging modality but stored in different formats. Although, the exemplary embodiments illustrated hereinafter are described in the context of a log file generated by a medical imaging system, it will be appreciated that use of the diagnostic system 10 (see FIG. 1) in analyzing machine readable data generated by different data sources are also contemplated in conjunction with the present technique.

As previously noted with reference to FIG. 1, the detection system 16 (see FIG. 1) of the diagnostic system 10 is configured to aid in the analysis of the log file, for example. More particularly, the detection system 16 may be configured to facilitate detection of faults associated with an imaging system, such as the first imaging system 12 (see FIG. 1), based on predefined rules. Accordingly, the data in the one or more log files may be processed by the detection system 16 to facilitate identification of faults associated with the first imaging system 12. In other words, the detection system 16 may be configured to extract information of interest from the input log file based upon one or more predefined rules.

Moreover, the predefined rules may be stored in a second storage, as previously noted. In a presently contemplated configuration, the second storage may include a rules database 76 that is configured to store the predefined rules. An example of a set of predefined rules that is stored in the rules database 76 will be described in greater detail with reference to FIG. 5. As previously noted, the term “rule” may be used to refer to a predefined constraint that typically encompasses any and all actions that should be taken within the scope of a problem. Also, the predefined rules may be representative of information associated with the status of a system, such as the medical imaging system 12. By way of example, the predefined rules may be employed to aid in detecting system status or health of the medical imaging system 12.

Further, as previously described, when one or more new detectable faults are identified by the first detection system 16, for example, it may be desirable to generate corresponding rules to aid the first detection system 16 in the detection of these newly identified faults. Also, it may be desirable to generate updated versions of existing rules, as previously noted. In accordance with exemplary aspects of the present technique, the rule management platform 26 (see FIG. 1) may be configured to aid in the generation of the desired rules.

In a presently contemplated configuration, the rule management platform 26 may include a rule authoring module 62, a rule packaging module 64 and a download module 66. Once one or more new detectable faults are identified, the rule authoring module 62 may be configured to author new rules, where the new rules may be employed to aid in the detection of the newly identified faults. Additionally, the rule authoring module 62 may also be configured to generate one or more tests, where the tests may be used to verify validity of the newly authored rules. Furthermore, the rule management platform 26 may also be configured to author updated versions of the existing rules. An output of the rule authoring module 62 may therefore include one or more newly authored rules, one or more updated rules, one or more tests, or a combination thereof. These new rules (newly authored rules and updated rules) and the set of tests may then be packaged via the rule packaging module 64 to generate a rule package. More particularly, the new rules and the set of tests may be packaged into the rule package to facilitate communication to the various remote detection systems. In accordance with further aspects of the present technique, the rule package may also include performance data associated with each rule in the rule package, where the performance data may be indicative of the performance of the rules during a verification and validation stage. The rule package may also include predetermined thresholds, where the predetermined thresholds may be configured to aid in determining performance of the rules. Hence, an output of the rule packaging module 64 may include a rule package, where the rule package may include the one or more new rules generated by the rule authoring module 62, a set of tests configured to verify the new rules, revised and/or updated versions of existing rules, performance data, predetermined thresholds, or a combination thereof.

The package of new rules may then be communicated to the download module 66. Once the rule package is generated, it may be desirable to communicate the rule package to one or more detection systems that are positioned at locations remote from the back-office system 20, thereby presenting a challenge of incrementing the knowledge base of the remote detection systems, when new rules are authored. Unfortunately, use of presently available techniques generally entails a manual method of updating the knowledge bases of the remote detection systems, thereby resulting in a laborious, time-consuming and often error-prone process. It may therefore be desirable to provide an automated method for deploying the new rules to facilitate updating the detection knowledge base of the various remotely located detection systems.

Accordingly, a method of automatically updating the detection knowledge base of the one or more remotely located detection systems by automatically deploying any newly authored rules is presented. In the example depicted in FIG. 3, the download module 66 in the rule management platform 26 may be configured to automatically communicate the package of new rules to the first detection system 16 via the first network 18, for example, thereby facilitating updating the detection knowledge base of the first detection system 16.

Once the rule package is communicated from the download module 66 to the first detection system 16, the first detection system 16 may be configured to provide a trigger to facilitate updating the corresponding detection knowledge base to incorporate the new rules in the rule package. Accordingly, the first detection system 16 may be configured to process the received rules to update the corresponding detection knowledge base, thereby facilitating enhanced detection of faults associated with the first and second imaging systems 12, 14 (see FIG. 1), for instance.

In a presently contemplated configuration, the first detection system 16 may be configured to include a remote connectivity module 68, a package validator module 70, a rule deployer module 72 and a rule enabler module 74, for example. The remote connectivity module 68 may be configured to aid the detection system 16 in receiving the rule package communicated by the download module 66 in the back-office system 20.

As noted hereinabove, the rule package includes newly authored rules, the set of tests configured to verify the new rules, revised and/or updated versions of existing rules, performance data, predetermined thresholds, or a combination thereof. The rule package received by the detection system 16 via the remote connectivity module 68 may then be communicated to the package validator module 70. In accordance with aspects of the present technique, the package validator module 70 may be configured to verify the validity of the received rule package. In other words, the package validator module 70 may be configured to validate integrity of the rule package, for instance. In addition, the package validator module 70 may be configured to verify the validity of the rules in the rules package. The package validator module 70 may be configured to verify the validity of the rules via use of the set of tests in the rule package.

Subsequent to the validation of the new rules, the package validator module 70 may also be configured to generate a report representative of success and/or failure of the new rules. In other words, the report may include a listing of valid or successful rules and invalid or failed rules. The valid rules may be representative of the rules that are successfully validated by the validator module 70, while rules that failed validation by the package validator module 70 may be indicative of invalid rules. Further, the report generated by the package validator module 70 may be communicated to the back-office system 20. In one embodiment, the report may be stored on a central server on the back-office system 20.

The valid rules may subsequently be communicated to the rule deployer module 72, where the rule deployer module 72 may be configured to locally deploy the valid rules. The valid rules may then be enabled via the rule enabler module 74. Once the valid rules are deployed and enabled, the detection system 16 may utilize these rules to detect faults associated with one or more imaging systems, such as imaging system 12 (see FIG. 1), for example. More particularly, the detection system 16 may be configured to detect faults by scanning log data generated by the imaging system 12 based upon the valid rules and/or the existing rules. It may be noted that, in accordance with exemplary aspects of the present technique, following the successful deployment of the new rules, the performance of the rules may be continually monitored.

By implementing the detection system as described hereinabove, the detection knowledge base associated with remote detection systems may be automatically updated, thereby eliminating need for manual intervention and enabling substantially faster turn-around time for incrementing the detection knowledge base of the remotely located detection systems.

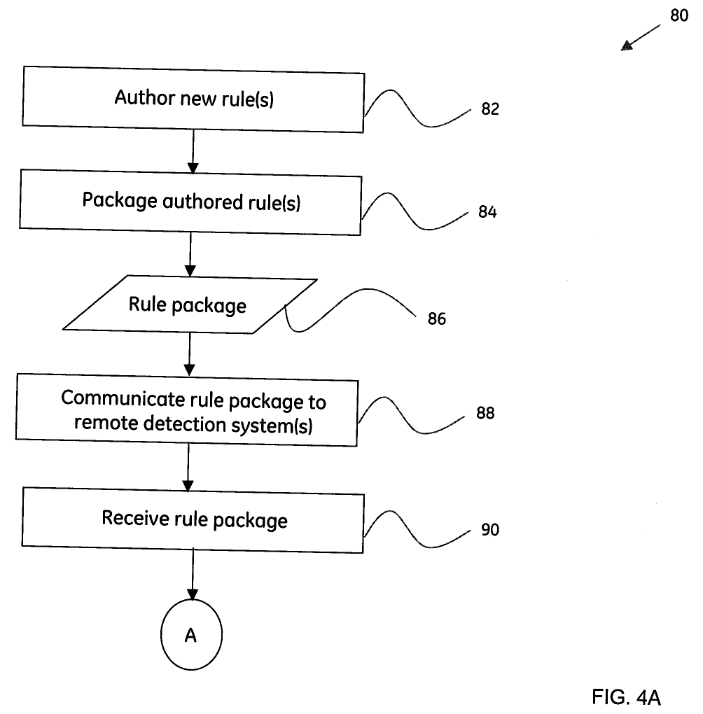

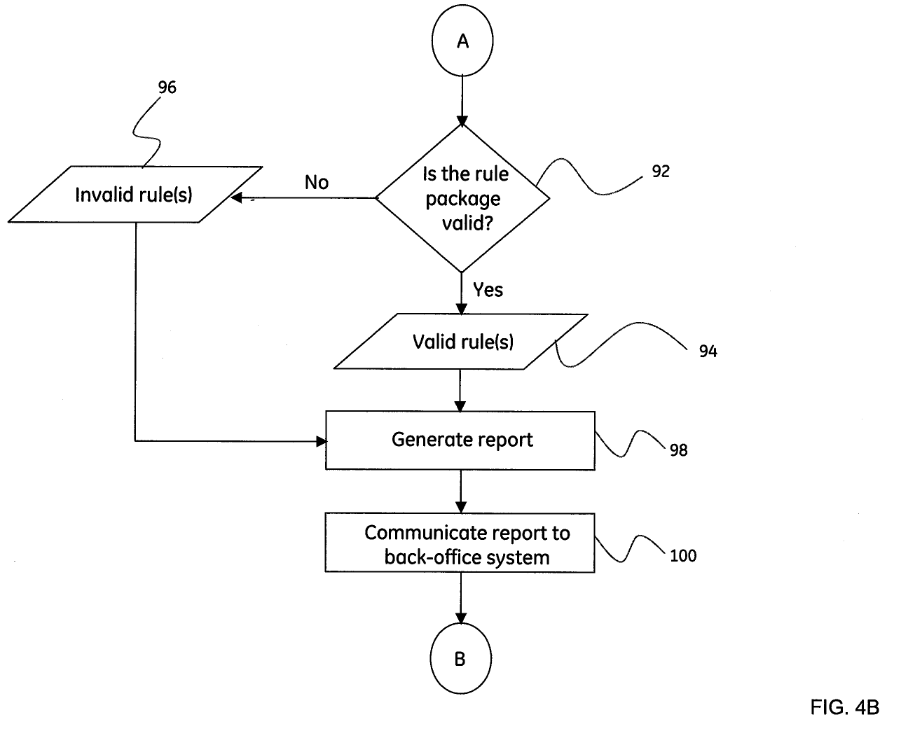

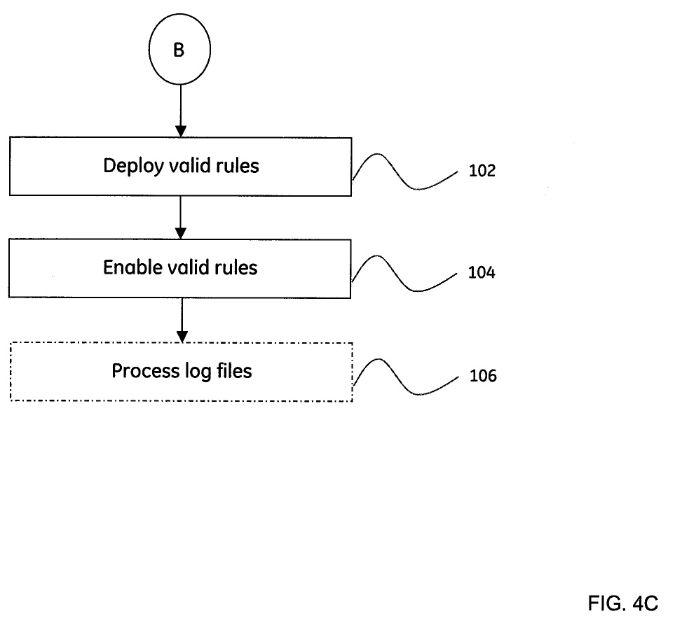

Turning now to FIGS. 4A-4C, a flow chart 80 illustrating an exemplary method for remotely updating the detection knowledge base of one or more systems is presented. In the present example, the method for remotely updating the detection knowledge base of a detection system is presented.

The method starts at step 82, where one or more new rules may be authored. As previously noted, identification of new detectable faults associated with imaging systems calls for generation of new rules to facilitate accurate detection of the newly identified faults. Accordingly, one or more new rules may be authored, where the new rules may be configured to aid in the detection of new faults. In addition, a set of tests may also be authored, where the tests are configured to allow validation of the newly authored rules. Furthermore, as previously noted, at step 82, updated versions of the existing rules may also be generated. The rule authoring module 62 (see FIG. 3) may be used to facilitate the generation of newly authored rules, the updated rules, and/or the corresponding tests, in certain embodiments.

Following the generation of the newly authored rules, the updated rules, and/or the corresponding tests, the new rules and tests may be packaged to generate a rule package 86, as depicted by step 84. Further, as previously noted, the rule package 86 may also include performance data, predetermined thresholds, or a combination thereof. The rule packaging module 64 (see FIG. 3) may be employed to generate the rule package 86.

In accordance with aspects of the present technique, the detection knowledge base of one or more detection systems may be incrementally updated via remote means. Accordingly, the rule package 86 may be communicated to the one or more remote detection systems as indicated by step 88. More particularly, once the rule package 86 is generated at step 84, the rule package 86 may be automatically communicated to one or more detection systems via corresponding networks, as indicated by step 88. For example, the download module 66 (see FIG. 3) may be used to communicate the rule package 86 to the one or more detection systems 16, 32 (see FIG. 1) via the corresponding networks 18, 34 (see FIG. 1).

Following the transmission of the rule package 86 via the networks, one or more detection systems may be configured to receive the transmitted rule package 86, as depicted in step 90. For example, the remote connectivity module 68 (see FIG. 3) in the first detection system 16 (see FIG. 3) may be configured to receive the transmitted rule package 86.

Additionally, it may be desirable to authenticate the validity of the rule package 86. Accordingly, a check may be carried out at step 92 to verify the validity of the rule package 86. For example, the package validator module 70 (see FIG. 3) may be employed to verify the validity of the rule package 86. At step 92, a check may also be carried out to verify the validity of the rules in the rule package 86. In certain embodiments, the set of tests in the rule package 86 may be utilized to verify the validity of the new rules. With continuing reference to step 92, if one or more new rules are successfully validated, a set of valid rules 94 may be obtained. However, at step 92, if one or more new rules fail the validation test, then a set of invalid rules 96 may be generated. Subsequently, at step 98, a summary report may be generated. This summary report may include information regarding the valid rules 94 and/or the invalid rules 96, in certain embodiments. Furthermore, at step 100, the summary report may be communicated to a data storage system, such as the back-office system 20 (see FIG. 1).

In addition, the valid rules 94 may be locally deployed as indicated by step 102. For example, the valid rules 94 may be locally deployed via the rule deployer module 72 (see FIG. 3). Following the local deployment of the valid rules 94, the valid rules 94 may be enabled, at step 104. In other words, the valid rules 94 may be configured for use by the detection systems in the detection of faults associated with imaging systems. The rule enabler module 74 may be employed to enable the valid rules, in one embodiment. Subsequently, the detection system 16 may be configured to scan the log files generated by the imaging systems to detect faults based upon the enabled valid rules and/or existing rules, as indicated by step 106.

By implementing the method of remotely enhancing the detection knowledge base of one or detection systems as described hereinabove, the new rules may be automatically deployed to one or more remote detection systems, thereby advantageously saving time of a service engineer and hence costs associated with manual intervention of the service engineer. Also, the status of the new rules may be easily accessed via the summary report.

An example 110 of predefined rules for use in the diagnostic system 10 (see FIG. 1) is illustrated in FIG. 5. These rules may be stored in the rules database 76 (see FIG. 3), in certain embodiments. In the illustrated example, the sample database 110 is shown as including three rules. More particularly, the sample rules database 110 is shown as including a first rule Rule1 112, a second rule Rule2 114, and a third rule Rule3 116. Reference numeral 118 may be representative of a rule name, while an identifier associated with a corresponding rule may be indicated by reference numeral 120. Furthermore, a description associated with a corresponding rule may generally be represented by reference numeral 122. In addition, a source of the rule may be represented by reference numeral 124. The source 124 may include the definition of the rule, in one embodiment. Also, a type of system where the rule may find application may be represented by reference numeral 126. By way of example, Rule1 112 may find application in both the CT/HELIOS system and the CT/LIGHTSPEED system, while Rule2 114 and Rule3 116 may be applied to only the CT/HELIOS system.

As described hereinabove, performance of the rules in the detection knowledge base of the detection systems may be continually monitored to study the performance of the rules. For example, the performance of the rules in accurately detecting faults may be monitored. In certain situations, it may be desirable to enable and/or disable one or more rules in the detection knowledge base of the detection system based on the performance of the rules. For example, if a rule is not performing as per predefined specifications, it may be desirable to disable that rule. Additionally, it may also be desirable to study the performance of the business rules from a business impact standpoint, and accordingly enable and/or disable a rule. More particularly, it may be desirable to remotely and/or locally enable and/or disable one or more rules in the detection knowledge base of the detection system.

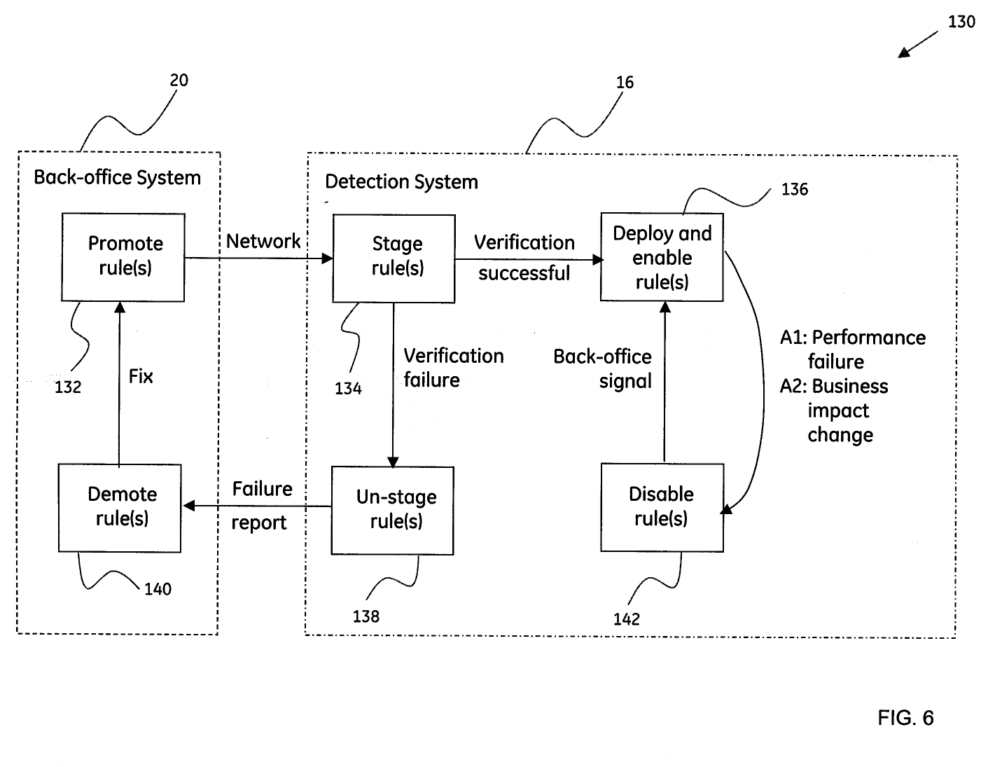

Accordingly, a method for remotely updating the detection knowledge base of one or more detection systems is presented. More particularly, a method for remotely enabling and/or disabling one or more rules in the detection knowledge base of one or more detection systems is presented. FIG. 6 is a diagrammatical illustration 130 of a method of remotely updating the detection knowledge base of one or more detection systems, in accordance with exemplary aspects of the present technique.

Here again, if one or more detectable faults are identified, it may be desirable to generate one or more corresponding new rules to facilitate the detection of these newly identified detectable faults by a detection system, such as the first detection system 16 (see FIG. 1). Accordingly, a system, such as the back-office system 20 (see FIG. 1) may be employed to generate the new rules. The back-office system 20 may also be configured to generate updated and/or revised versions of the existing rules. Further, these rules may be packaged to create a rule package. The rule package may include the newly authored rules, updated rules, and/or tests configured to aid in the validation of these new rules, as previously noted. Furthermore, this rule package may be communicated to one or more remote detection systems to update the corresponding detection knowledge base in the one or more remote detection systems. Accordingly, the back-office system 20 may be configured to generate the new rules, package the new rules into a rule package, and communicate the rule package via corresponding networks to the one or more remote detection systems, as indicated by step 132. By way of example, at step 132, the first network 18 (see FIG. 1) may be employed to facilitate promotion of the newly authored and packaged rules in the rule package from the back-office system 20 to the first detection system 16. It may be noted that in the present example only one detection system 16 is depicted. However, as will be appreciated, more than one detection system may be included.

Subsequently, the rule package may be received by the one or more detection systems. In the present example, the first detection system 16 may be configured to receive the rule package. As previously noted, the remote connectivity module 68 (see FIG. 3) in the first detection system 16 may be configured to receive the rule package. Once the rule package is received by the first detection system 16, the one or more rules in the rule package may be staged as indicated by step 134. More particularly, validity of the rule package may be verified. The package validator module 70 (see FIG. 3) may be employed to verify the validity of the rule package, as previously described. Moreover, the validity of the rules in the rule package may also be verified. Accordingly, at step 134, a check may also be carried out to verify if each of the one or more new rules includes a valid rule. Consequent to step 134, a set of valid rules and/or a set of invalid rules may be generated.

The set of valid rules may subsequently be deployed locally at step 136. For example, the rule deployer module 72 (see FIG. 3) may be utilized to deploy the valid rules locally. Additionally, at step 136, the deployed valid rules may also be enabled. The rule enabler module 74 (see FIG. 3) may be used to facilitate the enabling of the deployed valid rules.

The set of invalid rules generated at step 134 may be unstaged as indicated by step 138. Furthermore, a report may be generated, where the report may include a listing of valid rules and/or invalid rules. In the example illustrated in FIG. 6, the system is shown as generating a failure report, where the failure report may include a list of invalid rules. The report so generated may be communicated to the back-office system 20. In one embodiment, the report may be stored on a central server on the back-office system 20.

Furthermore, based on the failure report, the set of invalid rules may be demoted as indicated by step 140. The set of invalid rules may then be subject to further investigation in order to facilitate appropriate corrective action. Also, the back-office system 20 may be configured to communicate any corrective actions taken to modify the demoted rules to the one or more detection systems to once again update the corresponding detection knowledge base in the one or more detection systems. Subsequently, steps 132-140 may be repeated.

In accordance with yet another aspect of the present technique, the detection system may be configured to enable and/or disable one or more rules associated with systems that are operatively coupled to the detection system. However, the detection system may also be configured to enable and/or disable one or more rules associated with a particular system that is in operative association with the detection system.

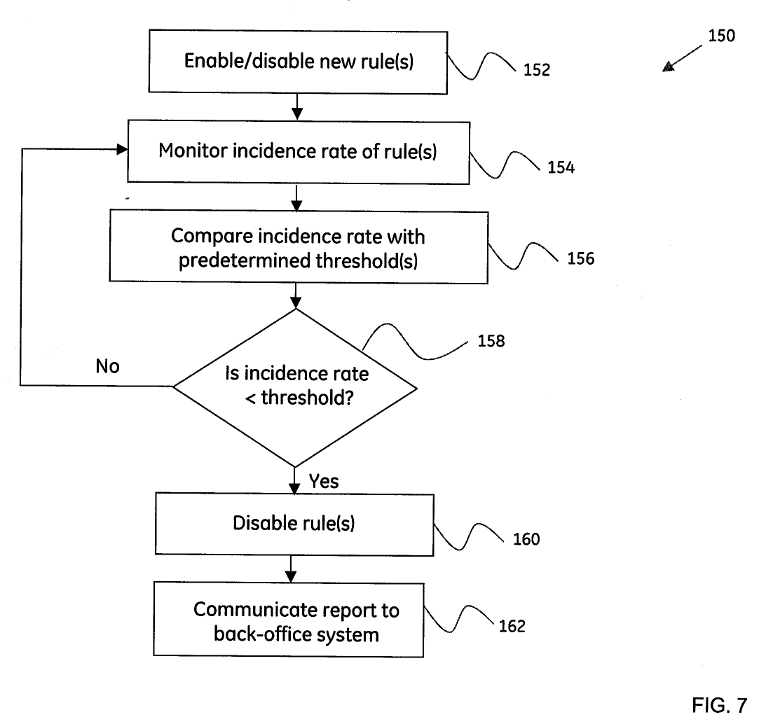

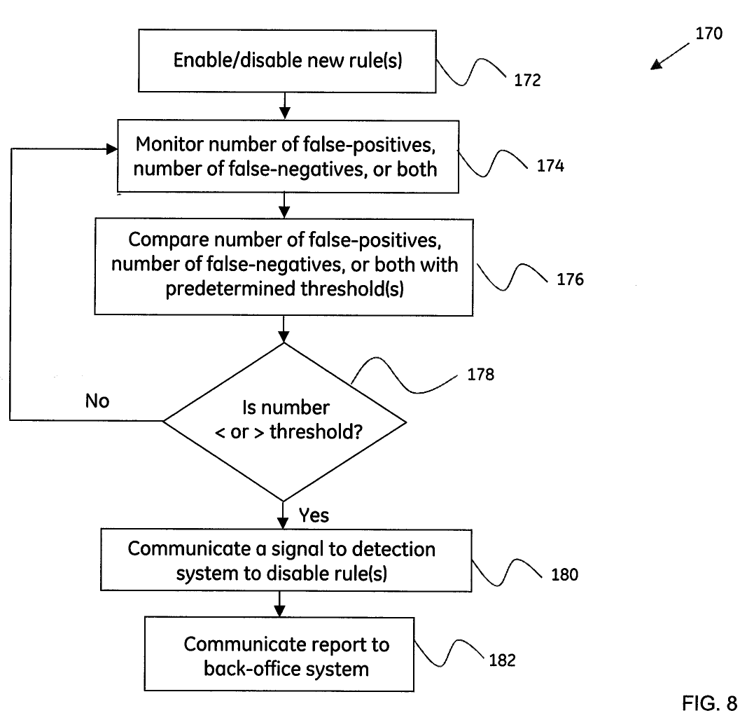

As previously described, performance of the rules may be continually monitored. In accordance with further aspects of the present technique, the new rules may be automatically enabled and/or disabled. Additionally, in accordance with aspects of the present technique, the new rules may also be remotely enabled and/or disabled. In other words, the rules in a detection system may be automatically and/or remotely enabled and/or disabled based on performance failure of the rules, business impact changes, or both, as indicated by step 142. Step 142 may be better understood with reference to FIGS. 7-8.

Turning now to FIG. 7, a flow chart 150 illustrating an exemplary method of updating the detection knowledge base of a detection system is depicted. More particularly, the method allows the rules to be automatically and/or remotely enabled and/or disabled based on the performance of the rules. The method starts at step 152, where it may be desirable to enable and/or disable one or more rules. It may be noted that the enabling and/or disabling of the rules may be triggered locally at the detection system. Alternatively, the enabling and/or disabling of the rules may be triggered in response to a signal from the back-office system 20 (see FIG. 1).

As noted hereinabove, in certain embodiments, the rules may be enabled and/or disabled based on the performance of the rules. Accordingly, an incidence rate of the one or more rules may be continually monitored for a predetermined period of time as indicated by step 154. Also, in one embodiment, incidence rate for each rule may be captured locally on each of the one or more remote detection systems. By way of example, in the example illustrated in FIG. 6, the incidence rate of each of the rules may be continually monitored over the predetermined period of time. In other words, the frequency at which each rule triggers an alert may be captured. Also, the predetermined time period may include weeks and/or months, for example.

Subsequently, at step 156, the incidence rate recorded at step 154 may be compared with a predetermined threshold. As previously noted, the predetermined thresholds may be communicated to the detection system via the rule package. The predetermined threshold may include a master rule, for example. Accordingly, at step 158 a check may be carried out to compare the incidence rate with the predetermined threshold to evaluate the performance of the rule. In one embodiment, if the incidence rate of the rule is less than the predetermined threshold, then the rule may be disabled, as indicated by step 160. In other words, the incidence rate of the rule being less than the predetermined threshold may be indicative of the fact that no faults have been identified by that rule in the predetermined time period. For example, if a format of log files has been modified, then the rule in a current form may not be able to accurately detect any failures based on the new format of the log files. Hence, it may be desirable to discontinue running the rule. In accordance with exemplary aspects of the present technique, the rule may be automatically disabled based on the performance of that rule. Once the rule is disabled, a report may be generated and communicated to the back-office system 20, as indicated by step 162. The rule may then be subject to further investigation in order to facilitate appropriate corrective action. Also, the back-office system 20 may be configured to communicate any corrective actions taken to modify the disabled rules to the one or more detection systems to once again update the corresponding detection knowledge base in the one or more detection systems.

With returning reference to the decision block 158, if it is determined that the incidence rate of the rule is greater than the predetermined threshold, then it may be inferred that the rule is performing as per design. Accordingly, monitoring of the incidence rate of that rule may be continued. It may be noted that the processing of steps 152-162 may be carried out in the detection system, in certain embodiments.

As previously noted, one or more rules in the detection system may be disabled in response to a trigger signal representative of a business impact change. The method starts at step 172, where it may be desirable to enable and/or disable one or more rules. It may be noted that the enabling and/or disabling of the rules may be triggered locally at the detection system. Alternatively, the enabling and/or disabling of the rules may be triggered in response to a signal from the back-office system 20.

It may be noted that at the back-office system 20 the performance of each rule may be continually monitored from a business impact perspective. The business impact may be measured in terms of false positives and/or false negatives. The term false negative may be used to represent a scenario where a corresponding rule fails to detect the presence of a failure. In a similar fashion, the term false positive may be used to represent a scenario where a corresponding rule falsely reports the presence of a failure. Additionally, the business impact may also be measured in terms of a number of alerts that are created for a rule. Accordingly, a number of false-positives, a number of false-negatives, or both, may be continually monitored, as indicated by step 174.

Subsequently, at step 176, the number of false-positives, the number of false-negatives, or both that are recorded at step 174 may be compared with a corresponding predetermined threshold. Also, the predetermined thresholds may be included in the rule package, as previously noted. The predetermined threshold may include a master rule, for example. Accordingly, at step 178 a check may be carried out to compare the number of false-positives, the number of false-negatives, or both with the corresponding predetermined threshold to evaluate the impact. In one embodiment, if the number of false-positives and/or the number of false-negatives is less than the predetermined threshold, then it may be desirable to disable the rule. Accordingly, the back-office system 20 may be configured to communicate a disable signal to one or more detection systems, where the disable signal may be indicative of the rule to be disabled, as depicted by step 180.

With continuing reference to step 178, in certain embodiments, if the number of false-positives and/or the number of false-negatives is greater than the predetermined threshold, then it may also be desirable to disable the rule. Accordingly, the back-office system 20 may be configured to communicate a disable signal to one or more detection systems, where the disable signal may be indicative of the rule to be disabled, as indicated by step 180. Consequently, based on a business impact change, one or more rules may be automatically disabled by the detection system. For example, if a root cause for a failure is fixed in all the installed bases, the corresponding rule may not trigger any alerts. Hence, it may be desirable to disable that rule.

Here again, once the rule is disabled, a report may be generated and communicated to the back-office system 20, as indicated by step 182. Furthermore, the rule may then be subject to further investigation in order to facilitate appropriate corrective action. In addition, the back-office system 20 may be configured to communicate any corrective actions taken to modify any rules to the one or more detection systems to once again update the corresponding detection knowledge base in the one or more detection systems. It may be noted that the processing of steps 172-182 may be carried out in the back-office system 20 (see FIG. 1).

As will be appreciated by those of ordinary skill in the art, the foregoing example, demonstrations, and process steps may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, such as C++ or Java. Such code, as will be appreciated by those of ordinary skill in the art, may be stored or adapted for storage on one or more tangible, machine readable media, such as on memory chips, local or remote hard disks, optical disks (that is, CDs or DVDs), or other media, which may be accessed by a processor-based system to execute the stored code. Note that the tangible media may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

The method for remotely updating detection knowledge base of one or more systems and the system for remotely updating the detection knowledge base of the one or more systems described hereinabove dramatically enhance the turn-around time for incrementing the detection knowledge base of the remote detection systems. Further, as the rules may be deployed automatically and/or remotely on one or more detection systems, precious time of the service engineer may be better utilized. Additionally, the time of the service engineer and the associated cost may be saved by automatically validating the new rules that are deployed on the remote detection system. Moreover, by having the remote detection system report its status back to back-office system 20, a consolidated report of the status of the rules may be viewed on a central server. Also, the system described hereinabove provides the ability to remotely and/or automatically enable and/or disable a rule in the detection knowledge base of a remote detection system, thereby saving time and cost.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for remotely updating a detection knowledge base of a system, the method comprising:
remotely communicating a rule package to the system to incrementally update the knowledge base of the system, wherein the rule package comprises at least one or more rules;
verifying validity of the rule package;
generating a set of valid rules, a set of invalid rules, or both;
deploying the set of valid rules; and
enabling the valid rules.

2. The method of claim 1, further comprising authoring the one or more rules.

3. The method of claim 2, further comprising packaging the one or more rules to generate the rule package.

4. The method of claim 1, wherein remotely communicating the rule package to the system comprises communicating the rule package from a data storage subsystem to the system via a network.

5. The method of claim 1, further comprising generating a report indicative of the set of valid rules, the set of invalid rules, or both.

6. The method of claim 5, further comprising communicating the report to a data storage system.

7. The method of claim 1, further comprising demoting the set of invalid rules.

8. The method of claim 1, further comprising remotely disabling one or more rules in response to a trigger signal.

9. The method of claim 8, wherein the trigger signal is generated in response to a performance failure, a business impact change, or both.

10. The method of claim 9, further comprising:
monitoring an incidence rate of the one or more rules;
comparing the incidence rate with a corresponding predetermined threshold; and
disabling one or more rules based on the comparison of the incidence rate with the corresponding predetermined threshold.

11. The method of claim 9, further comprising:
monitoring a number of false-positives, a number of false-negatives, or both;
comparing the number of false-positives, the number of false-negatives, or both with a corresponding predetermined threshold; and
disabling one or more rules based on the comparison of the number of false-positives, the number of false-negatives, or both with the corresponding predetermined threshold.

12. A computer readable medium comprising one or more tangible media, wherein the one or more tangible media comprise:
code adapted to remotely communicate a rule package to a system to incrementally update the knowledge base of the system, wherein the rule package comprises at least one or more rules;
code adapted to verify validity of the rule package;
code adapted to generate a set of valid rules, a set of invalid rules, or both;
code adapted to deploy the set of valid rules; and
code adapted to enable the valid rules.

13. The computer readable medium, as recited in claim 12, wherein the code adapted to communicate the rule package to the system comprises code adapted to communicate the rule package from a data storage system to the system via a network.

14. The computer readable medium, as recited in claim 12, further comprising code adapted to remotely disable one or more rules in response to a trigger signal.

15. The computer readable medium, as recited in claim 14, further comprising:
code adapted to monitor an incidence rate of the one or more rules;
code adapted to compare the incidence rate with a corresponding predetermined threshold; and
code adapted to disable one or more rules based on the comparison of the incidence rate with the predetermined threshold.

16. The computer readable medium, as recited in claim 14, further comprising:
code adapted to monitor a number of false-positives, a number of false-negatives, or both;
code adapted to compare the number of false-positives, the number of false-negatives, or both with a corresponding predetermined threshold; and
code adapted to disable one or more rules based on the comparison of the number of false-positives, the number of false-negatives, or both with the corresponding predetermined threshold.

17. A detection system, comprising:
a remote connectivity module configured to receive a rule package from a remote source, wherein the rule package comprises one or more rules;
a package validator module configured to:
verify validity of the rule package;
generate a set of valid rules, a set of invalid rules, or both;
a rule deployer module configured to deploy the set of valid rules; and
a rule enabler module configured to enable the deployed rules.

18. The detection system of claim 17, wherein the detection system is in operative association with at least one system, a data storage subsystem, or both.

19. The detection system of claim 17, wherein the one or more rules comprises a constraint, an action, or a combination thereof.

20. The detection system of claim 17, wherein the detection system is further configured to disable one or more rules in response to a trigger signal.

21. The detection system of claim 20, further configured to:
monitor an incidence rate of the one or more rules;
compare the incidence rate with a corresponding predetermined threshold; and
disable one or more rules based on the comparison of the incidence rate with the predetermined threshold.

22. The detection system of claim 20, further configured to:
monitor a number of false-positives, a number of false-negatives, or both;
compare the number of false-positives, the number of false-negatives, or both with a corresponding predetermined threshold; and
disable one or more rules based on the comparison of the number of false-positives, the number of false-negatives, or both with the corresponding predetermined threshold.

23. A system, comprising:
at least one data source, wherein the data source comprises:
an acquisition subsystem configured to acquire data;
a processing subsystem in operative association with the acquisition subsystem and configured to:
process the acquired data; and
generate log data;
a data storage subsystem, wherein the data storage subsystem comprises:
a data acquisition system configured to receive the log data;
a data repository configured to store the log data;
a rule management platform configured to:
author one or more rules based on the log data;
package the one or more authored rules to generate a rule package;
communicate the rule package to a detection subsystem;
a detection subsystem in operative association with the data storage subsystem, wherein the detection subsystem comprises:
a remote connectivity module configured to receive the rule package from the data storage subsystem, wherein the rule package comprises one or more rules;
a package validator module configured to:
verify validity of the rule package;
generate a set of valid rules, a set of invalid rules, or both;
a rule deployer module configured to deploy the set of valid rules; and
a rule enabler module configured to enable the deployed rules.

24. The system of claim 23, further configured to remotely disable one or more rules in the detection subsystem in response to a trigger signal.

25. The system of claim 23, wherein the data source comprises an imaging system, and wherein the imaging system comprises one of a computed tomography imaging system, a positron emission tomography imaging system, a magnetic resonance imaging system, an X-ray imaging system, a nuclear medicine imaging system, an ultrasound imaging system, or combinations thereof.
